(19) United States
(12) Patent Application Publication
(10) Pub. No.: US 2025/0234885 A1
(43) Pub. Date: Jul. 24, 2025

(54) Compact Countertop Drink Maker

(71) Applicant: SharkNinja Operating LLC, Needham, MA (US)

(72) Inventors: Stephanie Cugini, Weymouth, MA (US); Elizabeth Pellegrini, Watertown, MA (US); Cameron John Auger, Watertown, MA (US); Joyce Tu, Melrose, MA (US); Yaoming Deng, Shenzhen (CN); Bing Yin, Longyang (CN); Pei Zheng, Shenzhen (CN); Jared James Proulx, Northborough, MA (US); Michael Lerman, Providence, RI (US); Alexander Mularski, Auburn, MA (US); Macrae Benziger, Dedham, MA (US); Ryan Michienzi, Cumberland, RI (US)

(21) Appl. No.: 19/071,253

(22) Filed: Mar. 5, 2025

Related U.S. Application Data
(63) Continuation-in-part of application No. 18/415,817, filed on Jan. 18, 2024.

(51) Int. Cl. A23G 9/04; A23G 9/12; A23G 9/22; A23G 9/28

(52) U.S. Cl. CPC A23G 9/045; A23G 9/12; A23G 9/224; A23G 9/283

(57) ABSTRACT

A compact countertop drink maker is provided. The drink maker includes a mixing vessel configured to receive a drink product and a base configured to support the mixing vessel. The drink maker also includes a dasher configured to mix the drink product within the mixing vessel. The drink maker further includes a cooling circuit configured to cool the drink product within the mixing vessel. In some embodiments, a total height of the drink maker is less than 20 inches. Additionally, or alternatively, a maximum dimension of the mixing vessel along a vertical axis is greater than or equal to 40% of the total height of the drink maker.

### CROSS REFERENCE TO RELATED APPLICATION

This application is a continuation-in-part of U.S. patent application Ser. No. 18/415,817, filed on Jan. 18, 2024, the disclosure of which is hereby incorporated by reference in its entirety.

### BACKGROUND

### 1. Technical Field

The disclosure relates generally to drink makers and, in non-limiting embodiments or aspects, to a compact drink maker configured for positioning and use on a consumer home countertop.

### 2. Technical Considerations

Frozen drink makers, which also may be referred to as semi-frozen beverage makers or crushed-ice drink makers, may include a tank or mixing vessel in which a drink product is received and processed, including being cooled, often transforming the drink product from a pure liquid (or a combination of a liquid and portions of ice) to a frozen or semi-frozen product, such as, for example, a granita, slush drink, smoothie, ice cream, or other frozen or semi-frozen product, which is then dispensed. The cooled product may be dispensed through a tap, spigot, or dispenser. Thus, the term “frozen drink maker,” as used herein, is not limited to a device that only makes drinks or frozen drinks, but includes devices that cool received drink products to produce cooled outputs in any of a variety of cooled, frozen, and semi-frozen forms. A drink product may consist of a liquid mixture, including water, juice, or milk, and may include additives, such as sugar, spirit, syrup, or flavoring powders, that give the drink product the desired taste and/or color. Frozen drink makers may include a mixing system within the mixing vessel, and further may include a refrigeration system to cool the drink product in the mixing vessel.

Existing drink makers are bulky and inefficiently designed and, as a result, are either configured for commercial use (which allows for much larger machines) or may provide very little operational throughput (such as a single beverage serving). There is a need in the art for a compact drink maker that is both capable of positioning and use on consumer countertops (e.g., home kitchen countertops), while also maintaining a comparatively high operational throughput, such that multiple beverage servings may be processed at one time.

### SUMMARY

Accordingly, provided is an improved and compact drink maker configured for positioning and use on a consumer home countertop.

According to non-limiting embodiments or aspects, provided is a drink maker. The drink maker includes a mixing vessel configured to receive a drink product, a base configured to support the mixing vessel, a dasher configured to mix the drink product within the mixing vessel, and a cooling circuit configured to cool the drink product within the mixing vessel, wherein a total height of the drink maker is less than 20 inches.

In accordance with certain configurations, a total height of the drink maker is less than 18 inches. In other configurations, a vertical distance from a lowest point of the base to a lowest point of the mixing vessel is between 50% and 60% of the total height of the drink maker. The mixing vessel may be configured to hold a maximum liquid volume of the drink product that is greater than or equal to 64 fluid ounces. The mixing vessel may include a maximum fill indicator on a front face of the mixing vessel, and a vertical distance from a lowest point of the mixing vessel to the maximum fill indicator is greater than or equal to 65% of a maximum height of the mixing vessel.

In certain configurations, the drink maker further includes an evaporator configured to (i) enclose, on an interior of the evaporator, at least part of the cooling circuit, and (ii) contact, on an exterior of the evaporator, the drink product in the mixing vessel. A major axis of the evaporator may be substantially perpendicular to a vertical axis of the drink maker. The dasher may be configured to engage over at least part of the evaporator and rotate about a rotational axis that is parallel to the major axis of the evaporator. The dasher may be configured to urge the drink product from a first end of the mixing vessel to a second end of the mixing vessel, in a direction parallel to the major axis.

In certain configurations, the drink maker further includes a dispenser assembly disposed at the second end of the mixing vessel and configured to release the drink product from the mixing vessel. The drink maker may further include a drip tray detachably connectable to the base of the drink maker, and a spout fluidly connected to an interior of the mixing vessel and configured to direct the drink product that is released from the mixing vessel into a secondary container. A minimum vertical distance between a top surface of the drip tray and a bottom surface of the spout may be greater than or equal to 35% of the total height of the drink maker. A minimum vertical distance between a top surface of the drip tray and a bottom surface of the spout may be greater than or equal to 45% of the total height of the drink maker.

In certain configurations, the drink maker may further include a user interface for control of the drink maker, the user interface arranged on a front face of the drink maker in a space defined between the top surface of the drip tray and the bottom surface of the spout. A depth of an interior volume of the mixing vessel along a first axis may be greater than or equal to 50% of a total depth of the drink maker as measured along the first axis, wherein the first axis is perpendicular to the vertical axis and extends from a front of the drink maker to a rear of the drink maker. A width of an interior volume of the mixing vessel along a second axis may be greater than or equal to 65% of a total width of the drink maker as measured along the second axis, wherein the second axis is perpendicular to the first axis and perpendicular to the vertical axis. In certain configurations, the total width of the drink maker is less than or equal to 7 inches. The drink maker may also include a compressor connected to the cooling circuit, wherein the compressor is housed within the base, and wherein the compressor is arranged vertically below the mixing vessel.

In accordance with another embodiment of the present invention a drink maker includes a mixing vessel configured to receive a drink product, a base configured to support the mixing vessel, a dasher configured to mix the drink product within the mixing vessel, and a cooling circuit configured to cool the drink product within the mixing vessel, wherein a maximum height of the mixing vessel along a vertical axis is greater than or equal to 40% of a total height of the drink maker.

Optionally, the total height of the drink maker is less than 20 inches.

These and other features and characteristics of the present disclosure, as well as the methods of operation and functions of the related elements of structures and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1A is a perspective view of a drink maker on a countertop, according to some non-limiting embodiments or aspects;

FIG. 1B is a front view of a drink maker on a countertop, according to some non-limiting embodiments or aspects;

FIG. 1C is a side view of a drink maker on a countertop, according to some non-limiting embodiments or aspects;

FIG. 1D is a top view of a drink maker, according to some non-limiting embodiments or aspects;

FIG. 2 is a perspective view of a drink maker with exterior paneling and mixing vessel removed, according to some non-limiting embodiments or aspects;

FIG. 3A is a front view of a drink maker with a small beverage container, according to some non-limiting embodiments or aspects;

FIG. 3B is a front view of a drink maker with a medium beverage container, according to some non-limiting embodiments or aspects;

FIG. 3C is a front view of a drink maker with a large beverage container, according to some non-limiting embodiments or aspects;

FIG. 4A is a perspective view of a mixing vessel and dispenser assembly of a drink maker, according to some non-limiting embodiments or aspects; and

FIG. 4B is a front view of a mixing vessel and dispenser assembly of a drink maker, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, a controller, and/or the like).

To illustrate implementations clearly and concisely, the drawings may not necessarily reflect appropriate scale and may have certain structures shown in somewhat schematic form. The disclosure may describe and/or illustrate structures in one implementation, and in the same way or in a similar way in one or more other implementations, and/or combined with or instead of the structures of the other implementations.

In the specification and claims, for the purposes of describing and defining the present disclosure, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts.

The present disclosure, in various implementations, addresses deficiencies associated with drink makers, such as the inability to compactly arrange the components of a drink maker for use on consumer home countertops, and particularly below cabinets (e.g., kitchen cabinets). The present disclosure describes an arrangement of elements of a drink maker such that the drink maker may be assembled into a compact form factor that is small enough in height to fit in the gap between a top surface of a countertop and the bottom surface of a kitchen cabinet, small enough in width not to negatively displace other countertop appliances or workspace area, and small enough in depth not to hang off of the front lip of a consumer countertop. Furthermore, the compact form factor described herein is particularly arranged such that the total operational volume of a drink maker's mixing vessel is not significantly compromised by the compact form factor (e.g., multiple servings of frozen drink product may be prepared at the same time). In other words, the drink maker maintains high operational throughput despite its compact form.

A number of elements described herein contribute to a uniquely new compact form factor, including, but not limited to, a vertically arranged condenser, a vertically arranged condenser fan, a compressor positioned below a mixing vessel, a cylindrical evaporator positioned above the compressor and within the mixing vessel, a user interface positioned on a front face of the drink maker within the gap between a drip tray and a shroud of the dispenser assembly, a cooling fan airflow path directed from the back of the drink maker (e.g., intake) out the sides of the drink maker (e.g., output), pushing blades positioned on a rotating dasher that provide the force for expelling frozen drink product from the mixing vessel, a horizontally oriented mixing vessel, an integrated and removable condensation collection tray, and a removable and storable drip tray, among other elements. These elements, particularly when considered in their various combinations and sub-combinations, provide efficiencies in scale such that the final assembled drink maker is capable of being stored and used on consumer home countertops, with minimized width, depth, and vertical dimensions balanced with a high drink product output.

It should be appreciated that the various non-limiting embodiments and aspects described herein are not limited to making frozen or semi-frozen drinks, but may be applied to produce a cold drink product that is cooler than a received drink product, but not frozen or semi-frozen. For example, in some non-limiting embodiments or aspects, the same or similar mechanisms and/or techniques described herein may be used as part of a cold drink machine to produce, maintain, and dispense cold drinks.

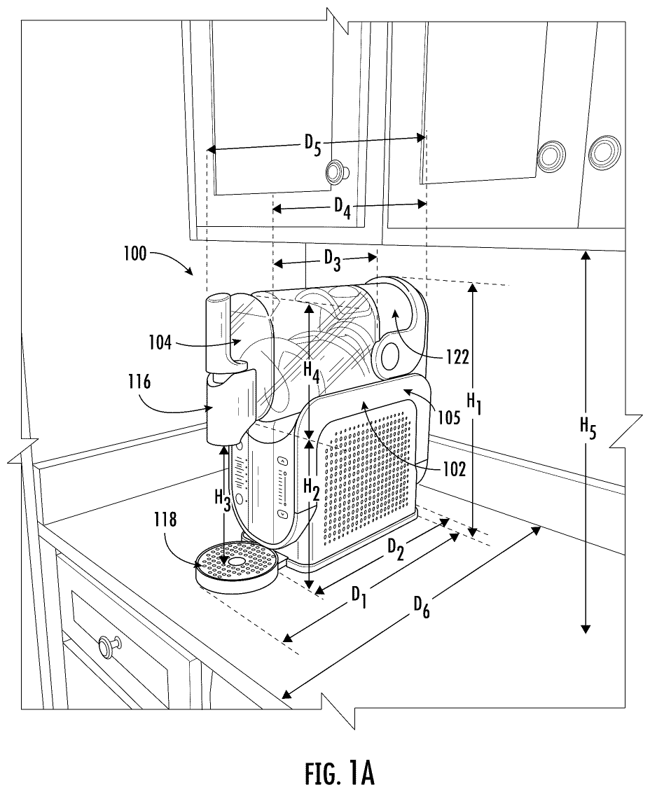

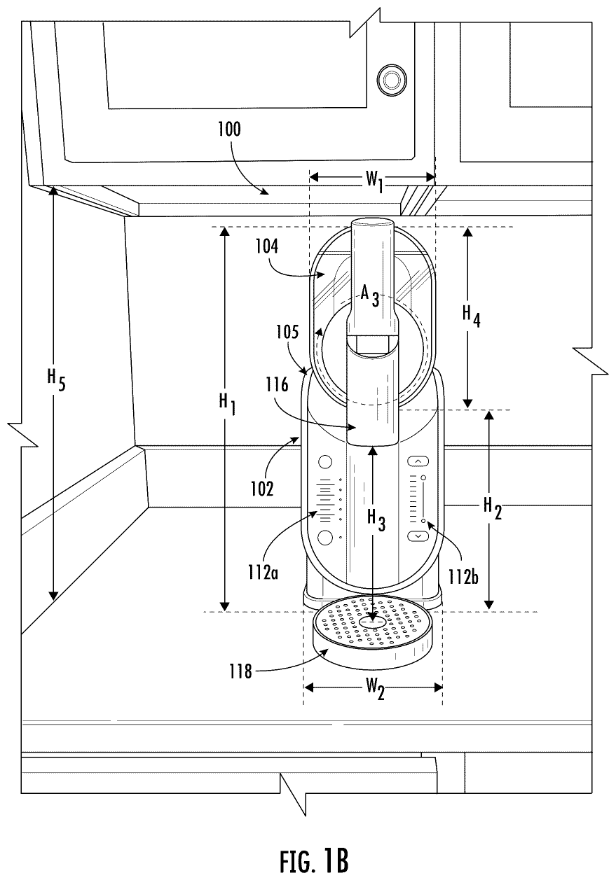

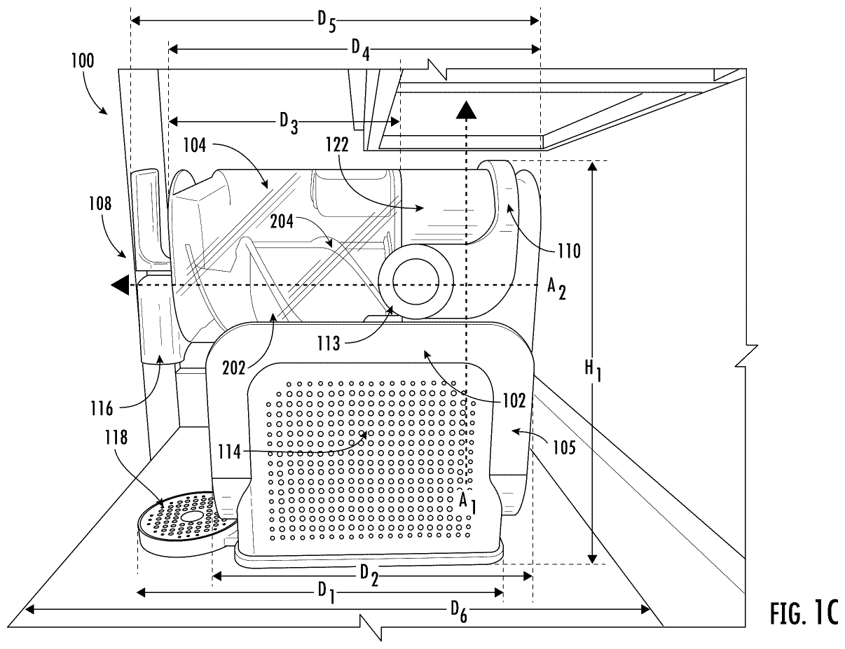

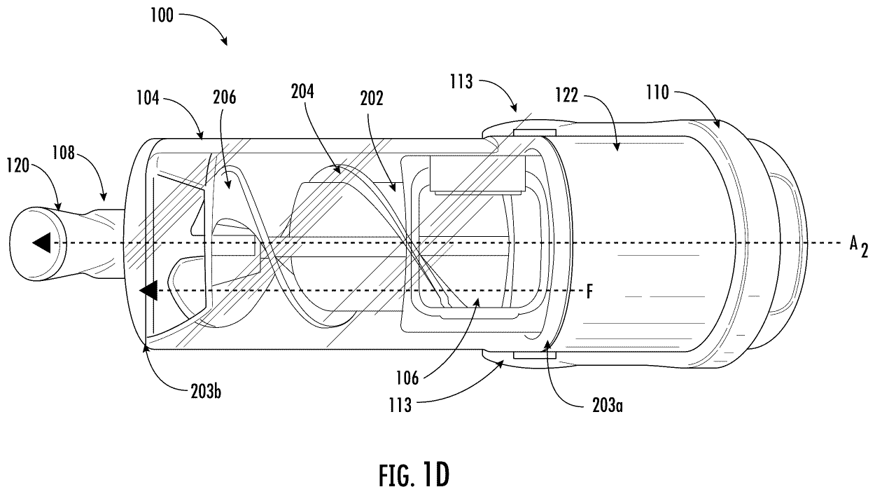

Referring now to FIGS. 1A-1D, shown are various views of a drink maker 100 (e.g., a frozen drink maker), according to some non-limiting embodiments or aspects. FIG. 1A shows a perspective view of drink maker 100 on a consumer home countertop (e.g., a kitchen countertop), FIG. 1B shows a front view of drink maker 100 on a consumer home countertop, FIG. 1C shows a side view of drink maker 100 on a consumer home countertop, and FIG. 1D shows a top view of drink maker 100. Each view of FIGS. 1A-1D provide further detail on the dimensions highlighted by that view, including emphasis on certain components of drink maker 100 and/or the environment that may be associated with such dimensions. It will be appreciated, however, that the same general arrangement of drink maker 100, including the components thereof, are illustrated in each view of FIGS. 1A-1D.

With further reference to FIGS. 1A-1D, drink maker 100 may include a housing 102 (e.g., a body of drink maker 100 enclosing at least some of the elements of drink maker 100) and a mixing vessel 104 (e.g., an at least partly enclosed volume for processing a drink product). Housing 102 may include a user interface 112 for receiving user inputs to control drink maker 100 (e.g., via one or more input devices), and/or for outputting information (e.g., via one or more output devices). User interface 112 may include one or more buttons, dials, switches, touchscreens, indicators, light-emitting diodes (LEDs), and the like. User interface 112 may display status information including, for example, a temperature of a drink product within mixing vessel 104, an indicator of a drink type (e.g., a recipe) and/or a program currently being implemented, a timer associated with the progress of the program currently being implemented, and/or the like. User interface 112 may provide indicators and/or warnings to a user regarding, for example, when a program is complete, when a user is expected to perform an action associated with processing a drink product, and/or the like. User interface 112 may include a selectable menu of drink types (e.g., recipes) and/or programs for different types of drink products such as, without limitation, granita, milkshake, frappé, frozen latte, slush drink, smoothie, margarita, daiquiri, piña colada, slushie, cool drink, semi-frozen drink, frozen drink, alcohol-based drink, non-alcohol-based drink, and the like, or any suitable combination of the foregoing. The compact form factor of drink maker 100 is provided, at least partly, by integrating user interface 112 with a recessed front face of drink maker 100 that is positioned between drip tray 118 and a spout (e.g., covered and/or formed by shroud 116).

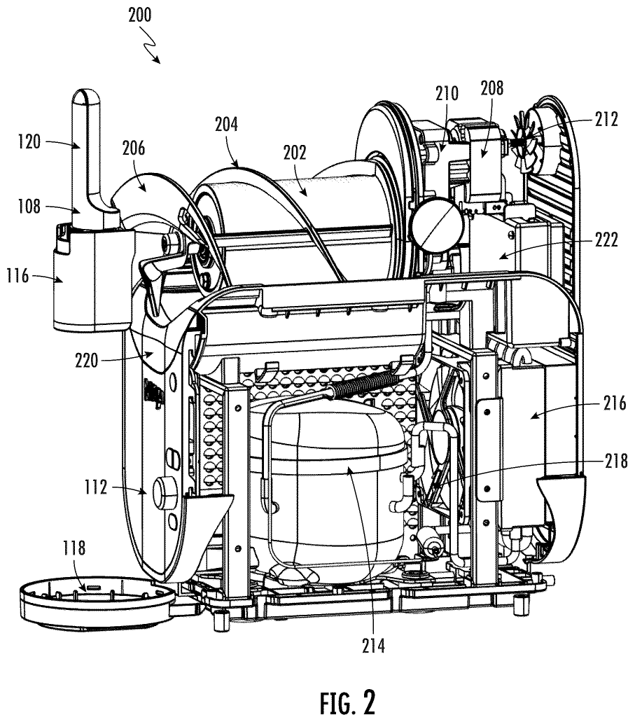

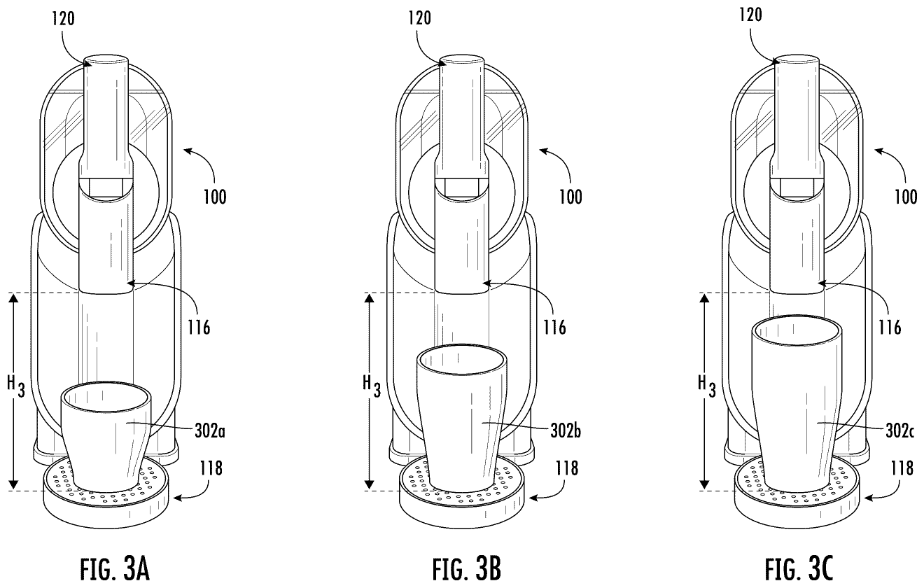

Housing 102 may include at least one ventilation panel 114 (e.g., an at least partly air-permeable wall) along a side of housing 102. Ventilation panel 114 may be removable from housing 102. Ventilation panel 114 may include a plurality of openings (e.g., holes) that facilitate air flow to aid in cooling components within housing 102. For example, a cooling fan (e.g., a compressor fan 218, as shown in FIG. 2) may draw cooler air into housing 102 through the rear of drink maker 100 (e.g., a real panel with vents) and expel warmer air from housing 102 through at least one ventilation panel 114. In some non-limiting embodiments or aspects, a ventilation panel 114 may be arranged on each opposing side of housing 102. For example, a first ventilation panel 114 is shown on a first side of drink maker 100 in FIG. 3, and a second ventilation panel 114 is shown on an opposing side of drink maker 100 in FIG. 2 (visible through the exposed interior). The compact form factor of drink maker 100 is provided, at least partly, by integrating ventilation panels 114 with vertical sides of housing 102, such that heat is allowed to dissipate more quickly from housing 102, allowing more compact cooling fans/devices to be used within housing 102.

Housing 102 may include an upper housing section 122 that is configured to couple with a rear end of mixing vessel 104 when mixing vessel 104 is attached to housing 102. Mixing vessel 104 may include walls, or a portion thereof, that are transparent to enable a viewer to see a drink product within mixing vessel 104 during processing. Mixing vessel 104 may include a pour-in opening 106, whereby mixing vessel 104 may receive a drink product for processing within mixing vessel 104. FIG. 1D, for example, shows pour-in opening 106 in a closed configuration with a hinged cover covering pour-in opening 106. The cover may be detachably removable and/or moveable to open or close pour-in opening 106. Pour-in opening 106 may be dimensioned (e.g., configured with a narrow gap into the internal chamber of mixing vessel 104) and/or include a grate (e.g., intermittent blocking elements arranged over the gap into the internal chamber of mixing vessel 104) to inhibit a user from reaching a digit into mixing vessel 104 when pour-in opening 106 is open (e.g., when the cover is not installed). Mixing vessel 104 may include a dispenser assembly 108 having a user handle 120 (e.g., for operating dispenser assembly 108), a spout (not shown), and a spout shroud 116 (e.g., a cover at least partly enclosing over and/or forming the spout on an interior surface). Dispenser assembly 108 may enable a user, by pulling down and/or outward on handle 120, to open a spout connected to a wall of mixing vessel 104, to dispense a processed (e.g., cooled) drink product from mixing vessel 104. The user may close the spout by pushing and/or releasing handle 120 back to an upright position (as shown in FIGS. 1A-1D) and, thereby, stop the dispensing of the processed drink product.

Drink maker 100 may include a lever 110 that enables a locked coupling of mixing vessel 104 to housing 102 (e.g., to upper housing section 122). As shown in FIGS. 1A, 1C, and 1D, for example, lever 110 is in a locked and/or closed position, whereby mixing vessel 104 is engaged and/or coupled to housing 102 (e.g., upper housing section 122). In the closed and/or locked position, lever 110 may help to ensure (e.g., along with other components and features) that there is a water-tight seal between mixing vessel 104 and housing 102, to prevent leakage of drink product from mixing vessel 104. Lever 110 may be placed in the closed, coupled, and/or engaged position by sliding mixing vessel 104 up to and against upper housing section 122 and then rotating lever 110 in a clockwise (e.g., rearward) direction until its handle rests on or about the top surface of upper housing section 122. Mixing vessel 104 may be disengaged and/or decoupled from housing 102 (e.g., upper housing section 122) by pulling and/or rotating lever 110 in a counter-clockwise (e.g., frontward) direction toward the front of mixing vessel 104, which may cause lever 110 to release mixing vessel 104 from housing 102. Once released, mixing vessel 104 may slide in a forward direction (e.g., away from upper housing section 122) to be fully detached and/or removed from housing 102. Drink maker 100 may also include drip tray 118 positioned below dispenser assembly 108 and configured to collect any processed drink product that is not properly dispensed from mixing vessel 104 to a receiving vessel, for example, a drinking cup. Drip tray 118 may be removably attachable to base 105 of housing 102 and may be stored on housing 102 (e.g., on a hook integrated with an exterior wall of housing 102, such as in ventilation panel 114).

In some non-limiting embodiments or aspects, when lever 110 is moved relative to upper housing section 122, lever 110 may activate a cam 113, which may engage mating features on mixing vessel 104 to either couple or uncouple mixing vessel 104 relative to upper housing section 122. In some non-limiting embodiments or aspects, lever 110 may move less than 90° relative to upper housing section 122 when moving between the coupled position and the uncoupled position. In some non-limiting embodiments or aspects, lever 110 may include two cams 113 positioned on opposing sides of upper housing section 122. In some non-limiting embodiments or aspects, lever 110 may include one, two, three, four, or more cams 113. As lever 110 is moved, cam 113 may rotate with respect to upper housing section 122 (e.g., when positioned on a right side of drink maker 100, such as in FIG. 1C, a counter-clockwise rotation with the raising of lever 110, as shown).

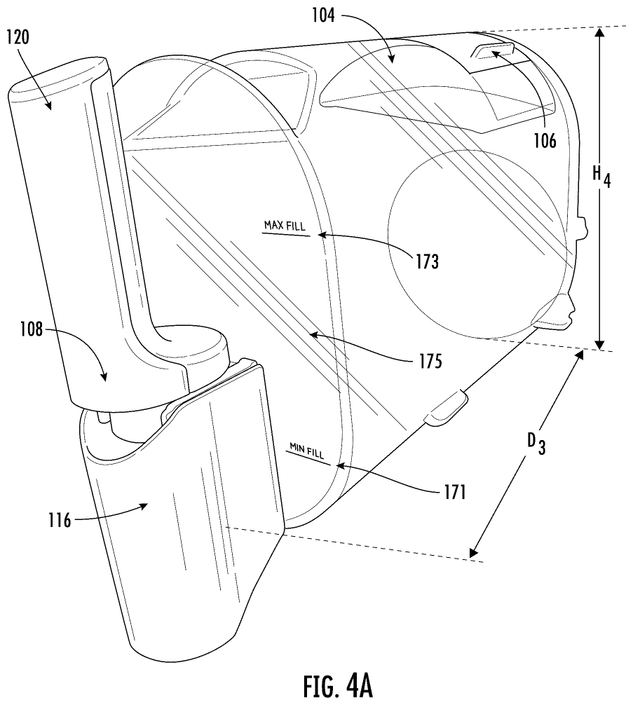

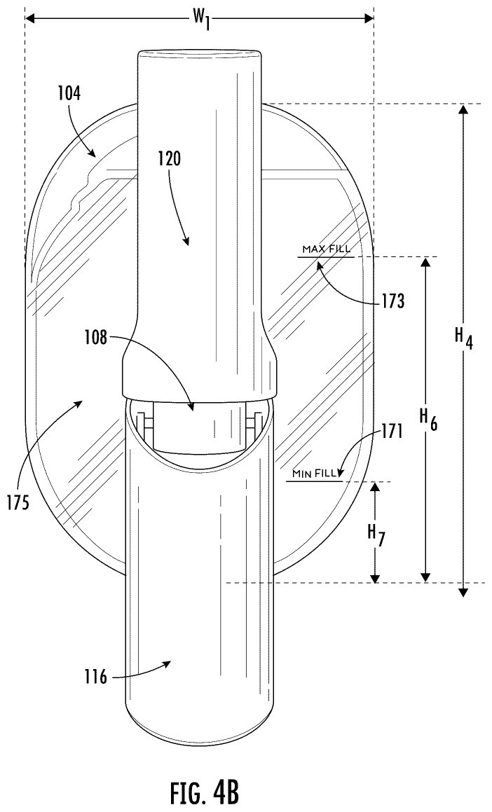

In some non-limiting embodiments or aspects, mixing vessel 104 may include protrusions on opposing outer sides, near the rear bottom of mixing vessel 104 (see, e.g., protrusions illustrated in FIG. 4A). The protrusions may be shaped and positioned to engage with cam 113 on lever 110. In particular, cam 113 may have channels and/or cam paths through which the protrusions slide, respectively. As cams 113 rotates toward the back of housing 102, the protrusions may slide along channels and/or cam paths and may be pulled toward upper housing section 122 and the rear of housing 102, causing mixing vessel 104 to press against upper housing section 122 and form a water-tight seal with housing 102. When cams 113 are rotated toward the front of drink maker 100, the protrusions may be pushed away from upper housing section 122, causing mixing vessel 104 to be decoupled from contact with upper housing section 122.

In some non-limiting embodiments or aspects, cam 113 may be an over-center cam, as shown in FIGS. 1A, 1C, and 1D, or cam 113 may have alternative geometry. Cam 113 may retain mixing vessel 104 on housing 102 when lever 110 is in the coupled position. Cam 113 may be positioned at least partly on an exterior of upper housing section 122, an interior of upper housing section 122, and/or the like. In some non-limiting embodiments or aspects, the protrusions of mixing vessel 104 may come into contact with channels and/or cam paths of cam 113 on an exterior of upper housing section 122. In some non-limiting embodiments or aspects, the protrusions of mixing vessel 104 may come into contact with channels and/or cam paths of cam 113 on an interior of upper housing section 122. In some non-limiting embodiments or aspects, cam 113 may be internal to upper housing section 122, and cam 113 may be separate from and mechanically coupled to lever 110. For example, when lever 110 (e.g., on the exterior of upper housing section 122) is moved, lever 110 may activate cam 113 (e.g., in the interior of upper housing section 122), which may engage mating features (e.g., protrusions) on mixing vessel 104 (e.g., on the interior of upper housing section 122) to couple mixing vessel 104 to upper housing section 122 (or disengage such mating features to uncouple mixing vessel 104 from upper housing section 122).

In some non-limiting embodiments or aspects, housing 102 may include base 105. Base 105 may be a part of housing 102 that is below upper housing section 122 and may be configured to support mixing vessel 104. For example, base 105 may include all of housing 102 that is primarily below mixing vessel 104, and upper housing section 122 may include all of housing 102 that is primarily in-line with and/or above mixing vessel 104. It will be appreciated, however, that base 105 may have an upper portion that is nonlinear in dimension (e.g., curved), to match an underside dimension of mixing vessel 104, such that mixing vessel 104 rests supported and secured by base 105. In such an example, portions of base 105 may rise above a lower portion of mixing vessel 104. In some non-limiting embodiments or aspects, base 105 may include ventilation panel 114. Base 105 may also include a receiving slot for at least part of drip tray 118. Base 105 may further include the lowest portion of drink maker 100, including a bottom panel, stabilizing feet (e.g., rubber feet), and/or the like.

In some non-limiting embodiments or aspects, drink maker 100 may include a power interface (not shown) configured to receive AC power from a power outlet. In some non-limiting embodiments or aspects, drink maker 100 may include one or more batteries housed within housing 102 and configured to provide power to various components of drink maker 100. Drink maker 100 may also include a mount (not shown) (e.g., a hook) on a side of housing 102 (e.g., ventilation panel 114) where drip tray 118 may be mounted when not in use, such as during storage and/or transport of drink maker 100.

With specific reference to FIGS. 1A and 1B, and in some non-limiting embodiments or aspects, drink maker 100 may be specifically configured with a compact form factor and arrangement of functional elements such that drink maker 100 may be stored and/or operated on a consumer home countertop (e.g., a kitchen countertop). For that particular application, drink maker 100 may be configured to fit at least within a maximum vertical dimension (dimension H₅) associated with a distance between a top surface of the countertop and a bottom surface of a cabinet. For example, dimension H₅ in standard homes may be upwards of approximately 20 inches, therefore, drink maker 100 may be configured with a total height (dimension H₁) of less than 20 inches. More average homes may have a dimension Hs with a value of approximately 18 inches, therefore, drink maker 100 may be configured with a total height (dimension H₁) of less than 18 inches. The total height of drink maker 100 (dimension H₁) may be measured as the total vertical distance from a lowest point of drink maker 100 (e.g., a bottom of base 105) to a highest point of drink maker 100 (e.g., a top of mixing vessel 104, handle 120, upper housing section 122, and/or lever 110).

As referenced above, drink maker 100 is configured to maintain significant operational output despite its overall compact total height. Therefore, drink maker 100 may be configured such that a maximum dimension of mixing vessel 104 along a vertical axis (dimension H₄) may be greater than or equal to 40% of the total height (dimension H₁) of drink maker 100. For example, if dimension H₁ is 17.5 inches tall, then dimension H₄ may be greater than or equal to 7 inches tall. This relative dimensioning may be accomplished, at least in part, by orienting mixing vessel 104 with a major axis that is horizontal to a vertical axis of drink maker 100 (e.g., parallel with the orientation of evaporator 202). Furthermore, this relative dimensioning may be accomplished, at least in part, by minimizing the number of functional elements that are arranged in-line with mixing vessel 104 inside upper housing section 122, such as gear assembly 210, drive motor 208, motor fan 212, and PCBA 222 (see FIG. 2). As such, dimension H₁ may be less than dimension H₅.

By configuring mixing vessel 104 with the form and dimensions as described herein, mixing vessel 104 may be able to hold a maximum liquid volume of drink product (e.g., a total space occupiable by liquid when mixing vessel 104 is mounted to housing 102 for processing of drink product) that is at least 64 fluid ounces (e.g., enough for four 16-ounce servings, or eight 8-ounce servings). In some non-limiting embodiments or aspects, the maximum liquid volume of the drink product that is able to be held by mixing vessel 104 may be at least 80 fluid ounces. It will be appreciated that one method of calculating maximum liquid volume of mixing vessel 104 may be, after coupling mixing vessel 104 to housing 102 in an operational configuration, to pour in measured liquid through pour-in opening 106 until no further liquid may enter an interior cavity of mixing vessel 104 without spilling out of the interior cavity (e.g., backing up into pour-in opening 106 and/or over the sides of mixing vessel 104).

In some non-limiting embodiments or aspects, drink maker 100 may be configured to permit placement of a receiving vessel (e.g., a beverage container, such as a cup) below a spout (e.g., within shroud 116) of drink maker 100, to receive the output drink product from drink maker 100. Moreover, mixing vessel 104 may be positioned on top of base 105 and above other functional elements of drink maker 100 that are housed in base 105. To accommodate the foregoing configuration, a vertical distance from a lowest point of base 105 to a lowest point of mixing vessel 104 (dimension H₂) may be between 50% and 60% (inclusively) of the total height of drink maker 100. For example, if dimension H₁ is 17.5 inches tall, then dimension H₂ may be between 8.75 inches and 10.5 inches tall (inclusively). Moreover, it will be appreciated that the vertical distance from a lowest point of base 105 to a lowest point of mixing vessel 104 (dimension H₂) plus a maximum dimension of mixing vessel 104 along a vertical axis (dimension H₄) may be less than or equal to a total height of drink maker 100 (dimension H₁). This relative dimensioning may be accomplished, at least in part, by nesting mixing vessel 104 inside a curvilinear space on the top of base 105, matching the bottom curve of mixing vessel 104 with a curve of condensation tray 220 (see FIG. 2), and placing certain functional components in-line with mixing vessel 104 (e.g., gear assembly 210, drive motor 208, motor fan 212, and PCBA 222, shown in FIG. 2).

In some non-limiting embodiments or aspects, drink maker 100 is configured to permit placement of a receiving vessel below a spout of drink maker 100 and above drip tray 118. Moreover, drink maker 100 may be configured with a front panel that permits user interaction (e.g., user interfaces 112a, 112b, shown larger in FIG. 1B). To accommodate the foregoing configuration, a minimum vertical distance between a top surface of drip tray 118 and a bottom surface of the spout (e.g., shroud 116) (dimension H₃) may be greater than or equal to 35% of the total height of drink maker 100 (dimension H₁). In some non-limiting embodiments or aspects, the minimum vertical distance between a top surface of drip tray 118 and a bottom surface of the spout (dimension H₃) may be greater than or equal to 45% of the total height of drink maker 100 (dimension H₁). For example, if dimension H₁ is _{17.5} inches tall, then dimension H₃ may be at least 6.125 inches tall, or at least 7.875 inches tall. In this manner, dimension H₃ may be configured to permit placement of receiving vessels of various sizes on drip tray 118, such as an 8 oz cup (e.g., about 3.5 inches tall), a 12 oz cup (e.g., about 5 inches tall), a 16 oz cup (e.g., about 6 inches tall), and/or the like. See FIGS. 3A-3C for further detailed description of dimension H₃ and the placement of various receiving vessels.

With specific reference to FIGS. 1A and 1C, in addition to fitting in the gap between countertop and cabinet that is demarcated by dimension H₅, drink maker 100 may be configured to fit in the gap between a rear edge of countertop (e.g., a back splash) and a front edge of countertop (the total gap demarcated by dimension D₆). The depth between the rear edge and the rear surface may have dimension D₆, representing an absolute maximum depth before drink maker 100 would not fit entirely on the surface demarcated by dimension D₆. The total footprint depth of drink maker 100 when drip tray 118 is attached may be represented by dimension D₁. As such, dimension D₁ may be less than dimension D₆. For example, standard kitchen countertops may have a countertop depth (dimension D₆) of 25.5 inches. Kitchen island countertops may be deeper, e.g., at 27-30 inches. Accounting for a rear back splash that may be mounted on a standard kitchen countertop, a standard kitchen countertop may have a workable surface depth (dimension D₆) of 25 inches. By way of further example, if dimension D₆ is 25 inches, dimension D₁ may be less than or equal to 18 inches. In this manner, ample workspace remains in front of or behind drink maker 100, to allow for maneuvering an AC power plug into an outlet, staging receiving vessels in front of drip tray 118, and/or the like. Furthermore, this relative dimensioning may be accomplished, at least in part, by vertically orienting condenser 216 inside housing 102, stacking functional elements within housing 102 (e.g., gear assembly 210, drive motor 208, motor fan 212, and PCBA 222 above compressor 214, condenser 216, and condenser fan 218), and making user interface 112 flush on a recessed front panel of housing 102 (see FIG. 2).

In some non-limiting embodiments or aspects, the total upper depth of drink maker 100 (dimension D₅) may be configured to fit within the confines of dimension D₆. In this manner, a user may be prevented from accidentally bumping into a front of drink maker 100 when working or moving past drink maker 100. For example, if dimension D₆ is 25 inches, dimension D₅ may be less than or equal to 17 inches. This relative dimensioning may be provided by compactly arranging functional elements within upper housing section 122 (e.g., drive motor 208, gear assembly 210, motor fan 212, and PCBA 222, as shown in FIG. 2), and by limiting the total depth of mixing vessel 104 (dimension D₃) and the total depth of upper housing section 122 (e.g., dimension D₄-dimension D₃). For example, the depth of mixing vessel 104 and upper housing section 122 combined (dimension D₄), plus the depth of dispenser assembly 108 (which includes shroud 116), may be dimension D₅, which is the total upper depth of drink maker 100. The depth of drink maker 100 when mixing vessel 104 and drip tray 118 is removed may be dimension D₂, which may be considered the minimum disassembled depth of drink maker 100. Therefore, dimension D₂ may be configured to allow for even more compact storage, such as for shallow cabinets, shipping, and/or the like. In some non-limiting embodiments or aspects, dimension D₁ may be approximately equal to dimension D₅. In some non-limiting embodiments or aspects, one or more edges that bound dimension D₁ and dimension Ds may be coextensive.

With specific reference to FIG. 1B, and in some non-limiting embodiments or aspects, drink maker 100 may include a user interface 112 on a front surface of housing 102, and user interface 112 may include a first user interface 112a (e.g., positioned on a left-side front panel) and a second user interface 112b (e.g., positioned on a right-side front panel). User interface 112 may include one or more user input devices, including, but not limited to, a keyboard, keypad, one or more buttons, dials, touchpad, or sensor readout (e.g., biometric scanner), and one or more output devices, such as displays, speakers for audio, and/or light indicators (e.g., LED indicators). In some non-limiting embodiments or aspects, first user interface 112a may include a power button, a drink type selector/indicator panel, a clean button (e.g., a rinse button), and/or the like. In some non-limiting embodiments or aspects, second user interface 112b may include manual temperature adjustment (or offset) indicators, manual temperature adjustment buttons, temperature/process feedback indicators (e.g., LED indicators), and/or the like.

In some non-limiting embodiments or aspects, a user may turn drink maker 100 on or off using a power button of first user interface 112a. A user may select a drink type in first user interface 112a to process a type of drink product by pressing a button associated with a selected drink type, e.g., slush. The selection of a particular drink type may be indicated by illumination of a light indicator associated with the selected drink type button. The user may select, for example, a slush drink, spiked slush drink or cocktail, a frappé, a frozen juice, or a dairy/milkshake drink type. The user may press manual temperature adjustment buttons in second user interface 112b to set the target temperature value within a universal range of target temperature values. For example, the manual temperature adjustment indicator may include 10 temperature values or settings corresponding to target temperature values.

In some non-limiting embodiments or aspects, first user interface 112a may include a clean button. A controller of drink maker 100 may be configured to, in response to the clean button being pressed by a user, activate the rotation of dasher 204 but not the cooling circuit (e.g., including evaporator 202, compressor 214, condenser 216, condenser fan 218, etc.). If dasher 204 and the cooling circuit are active when the clean button is pressed, the controller may deactivate the cooling circuit and leave dasher 204 active. A user may then add water (e.g., warm water) to mixing vessel 104 through pour-in opening 106, and the action of dasher 204 may agitate the water and may push the water forward to assist in dislodging and/or melting ingredients from the surfaces of evaporator 202, dasher 204, mixing vessel 104, and/or the like. The user may then dispense the contents of mixing vessel 104 and repeat filling with water and dispensing as desired (e.g., including some form of cleaner in earlier cycles to help clean, and only water in later cycles to rinse). Deactivating or leaving off the cooling circuit during cleaning may help thaw any frozen ingredients and prevent freezing of contents during cleaning.

In some non-limiting embodiments or aspects, drink maker 100 may be configured to minimize disruption of the countertop workspace by minimizing the total footprint width of drink maker 100 (dimension W₂). If drink maker 100 is overly wide, then other countertop appliances may be displaced, effective workspace may be reduced, drink maker 100 may not fit on narrow countertop strips, and/or the like. To achieve the relative dimensioning of reducing the total footprint width of drink maker 100 (dimension W₂), certain functional elements may be arranged front-to-back, rather than side-to-side (e.g., the front-to-back arrangement of gear assembly 210, drive motor 208, motor fan 212, and PCBA 222, shown in FIG. 2, or the front-to-back arrangement of compressor 214, condenser fan 218, and condenser 216, also shown in FIG. 2). Moreover, width may be minimized by arranging the major axis of evaporator 202 and mixing vessel 104 as front-to-back, rather than side-to-side (see FIGS. 1C and 1D, depicting major axis A₂ of mixing vessel).

In some non-limiting embodiments or aspects, the volume of mixing vessel 104 may be increased (e.g., in balance with a reduced machine width) by assuring that the total width of mixing vessel 104 (dimension W₁) is increased relative to footprint width (dimension W₂). This increase in the volume of mixing vessel 104 may be balanced against the overall dimensional width of drink maker 100, such that the width of mixing vessel 104 (dimension W₁) is minimally less than or equal to the footprint width (dimension W₂), and such the sides of housing 102 are approximately the same width apart as the footprint width (dimension W₂).

In some non-limiting embodiments or aspects, a dimension of an interior volume of mixing vessel 104 along a second axis (e.g., parallel to dimension lines for W₁ and W₂) that is perpendicular to a first axis (see, e.g., axis A₂, shown in FIGS. 1C and 1D) may be greater than or equal to 65% of the total width of drink maker 100 as measured along that second axis. For example, if the total width of drink maker 100 (dimension W₂) is 6.5 inches, the dimension of an interior volume of mixing vessel 104 (e.g., dimension W₁ minus minor thickness for walls of mixing vessel 104) may be greater than or equal to 4.225 inches. In this manner, the operational volume of mixing vessel 104 is not reduced by overly shrinking mixing vessel 104 relative to housing 102, but neither is the overall width of drink maker 100 overly expanded by an oversized mixing vessel 104.

With specific reference to FIGS. 1C and 1D, drink maker 100 may include an evaporator 202 that is configured to enclose, on an interior of evaporator 202, at least part of the cooling circuit (e.g., refrigerant coils within a metal drum of evaporator 202). Evaporator 202 may be further configured to contact, on an exterior of evaporator 202, the drink product in mixing vessel 104. To reduce an overall vertical dimension of drink maker 100, a major axis of evaporator 202 (axis A₂) may be arranged substantially perpendicular to a vertical axis (axis A₁, shown in FIG. 1C) of drink maker 100. Drink maker 100 may further include a dasher 204 that is configured to engage over at least part of evaporator 202 and rotate about a rotational axis that is parallel to the major axis of evaporator (axis A₂). As illustrated, the rotational axis of dasher 204 is coextensive with a central axis of evaporator 202 that proceeds along axis A₂ (the rotation of dasher 204 is represented by axial rotation path A₃ shown in FIG. 1B).

In some non-limiting embodiments or aspects, a dimension of an interior volume of mixing vessel 104 along a first axis (e.g., axis A₂, front-to-back, with respect to dispenser assembly 108) may be greater than or equal to 50% of a total depth of drink maker 100 as measured along the first axis. The first axis (axis A₂) may be perpendicular to a vertical axis of drink maker 100 (axis A₁, shown in FIG. 1C) and may extend from a front of drink maker 100 to a rear of drink maker 100. For example, for a total depth of drink maker 100 (dimension D₅) equaling 16 inches, a depth of an interior volume of mixing vessel 104 (e.g., dimension D₃, minus minor thickness for walls of mixing vessel 104) may be greater than or equal to 8 inches.

With specific reference to FIG. 1D, dasher 204 may be configured to urge the drink product from a first end 203a of mixing vessel 104 to a second end 203b of mixing vessel 104, in a direction parallel to the major axis of evaporator 202 (axis A₂). The rotational movement of dasher 204 may apply at least a partial force to the drink product in a direction (F) parallel with the major axis (axis A₂). When drink product is proximal to second end 203b, at least one blade 206 of dasher 204 may be configured to further push the drink product out of dispenser assembly 108 disposed at second end 203b of mixing vessel 104. Dispenser assembly 108 may be configured to release the drink product from mixing vessel 104. Dispenser assembly 108 may include a handle 120 that, when pulled by a user, allows the drink product to flow out a spout within shroud 116. The spout may be fluidly connected to an interior of mixing vessel 104 (e.g., a lower, front zone thereof) and may be configured to direct the drink product that is released from mixing vessel 104 into a secondary container, such as a receiving vessel (e.g., a cup).

With further reference to FIGS. 1A-1D, and in operation in certain implementations, a user may fill mixing vessel 104 via pour-in opening 106 with ingredients associated with a drink product. The user may select the type of drink product to be processed via user interface 112 (e.g., first user interface 112a), e.g., the user selects the recipe for “slush.” In some implementations, the user may select the product type and/or recipe before filling mixing vessel 104, and user interface 112 may provide one or more indicators or queues (e.g., visible and/or audible queues) that instruct the user to add ingredients to mixing vessel 104. Mixing vessel 104 may include one or more fill sensors that detect when a sufficient amount or level of ingredients and/or fluid is within mixing vessel 104. The one or more fill sensors may provide a signal to a processor (not shown) that indicates when mixing vessel 104 is sufficiently filled or not filled. The processor may prevent operations of drink maker 100 (e.g., prevent activation of a motor and/or other components) if the fill sensor(s) indicate that mixing vessel 104 is not sufficiently filled. A lid sensor may be associated with opening 106 whereby the lid sensor sends an open and/or closed signal to the processor that indicates whether opening 106 is open or closed. The processor may prevent operations of drink maker 100 if the lid sensor indicates that opening 106 is open and/or not closed. Depending on the sensed condition, user interface 112 may provide an indication regarding the condition, e.g., that mixing vessel 104 is sufficiently filled or not sufficiently filled and/or that opening 106 is not closed, to enable a user to take appropriate action(s).

Once mixing vessel 104 is filled with ingredients, the user may provide an input, e.g., a button press, to start processing of the drink product based on the selected recipe. Processing may include activation of motor 208 (see FIG. 2) to drive rotation of dasher 204 and/or blade 206 (see FIG. 1D) to effect mixing of the ingredients of the drink product. Processing may also include activation of the refrigeration system (e.g., the cooling circuit) including activation of compressor 214 and condenser fan 218 (see FIG. 2). The compressor 214 facilitates refrigerant flow through one or more coils of evaporator 202 and through condenser 216 (see FIG. 2) to provide cooling and/or temperature control of the drink product within mixing vessel 104. The processor may control operations of various components, such as motor 208 and compressor 214. To regulate temperature at a particular setting associated with a recipe, the processor may activate/start and/or de-activate/stop compressor 214 to start and/or stop refrigerant flow through the coil(s) of evaporator 202 and, thereby, start or stop cooling of the drink product within mixing vessel 104.

By cooling a drink product to a particular temperature, slush and/or ice particles may be formed within the drink product. The amount of particles and/or texture of a drink product may correspond to a temperature of the drink product, e.g., the cooler the temperature, the larger the amount of particles (and/or the larger the size of particles) and/or the more slushy the drink product. User interface 112 may enable a user to fine tune and/or adjust a preset temperature associated with a recipe to enable a user to adjust the temperature and/or texture of a drink product to a more desirable temperature and/or texture. In some non-limiting embodiments or aspects, mixing vessel 104 may be shaped such that a distance from the center axis of the dasher 204 (see, e.g., axis A₂ in FIGS. 1C and 1D) to the top of the vessel chamber is less than 6 inches, less than 8 inches, less than 10 inches, or less than 12 inches.

The processor of drink maker 100 may perform processing of the drink product for a set period of time in one or more phases and/or until a desired temperature and/or texture is determined. The processor may receive one or more temperature signals from one or more temperature sensors (not shown) within mixing vessel 104 to determine the temperature of the drink product. In some non-limiting embodiments or aspects, the processor may determine the temperature of the drink product by determining an average temperature among temperatures detected by multiple temperature sensors. In some non-limiting embodiments or aspects, the processor may determine the temperature of the drink product based on the detected temperature from one sensor within mixing vessel and/or based on a temperature of the refrigerant detected by a refrigerant temperature sensor. Once a phase and/or sequence of a recipe is determined to be completed by the processor, the processor may, via user interface 112, provide a visual and/or audio indication that the recipe is complete and ready for dispensing. In response, a user may place a cup or container below dispenser assembly 108 (see, e.g., FIGS. 3A-3C) and pull handle 120 rotationally downward towards the user to open a spout located at the lower front wall of mixing vessel 104, resulting in dispensing of the drink product into the cup or container. Once filled, the user may close the spout by pushing handle 120 back rotationally upward away from the user to its upright position (shown in FIGS. 1A-1D). In implementations where handle 120 is spring-biased to the closed position, the user may release their hold of handle 120 and, thereby, allow a spring force to move handle 120 back rotationally upward away from the user to the upright and closed position.

Referring now to FIG. 2, shown is a view 200 of various internal components within housing 102 and mixing vessel 104 of drink maker 100 of FIGS. 1A-1D, according to some non-limiting embodiments or aspects. Drink maker 100 may include a cylindrical evaporator 202 (e.g., a heat exchanger that absorbs thermal energy from the drink product) that is surrounded by a dasher 204 (e.g., an auger). Evaporator 202 may include and/or be enclosed by a cylindrical drum (e.g., a smooth metal housing configured to act as a surface for drink product to contact and exchange heat energy with evaporator 202). Dasher 204 may include one or more mixing blades and/or protrusions that extend helically around evaporator 202. Dasher 204 may be driven to rotate by a central drive shaft within mixing vessel 104. The drive shaft may be surrounded by evaporator 202, and evaporator 202 may be configured in a fixed position while drive shaft rotates within evaporator 202. The drive shaft may be coupled via a gear assembly 210 to a drive motor 208. In some non-limiting embodiments or aspects, drive motor 208 may be an alternating current (AC) motor, but another type of motor may be used such as, without limitation, a direct current (DC) motor. Drive motor 208 may include a motor fan 212 configured to provide air cooling for motor 208. While FIG. 2 shows an implementation where drive motor 208 is not coaxially aligned with the drive shaft used to rotate dasher 204, in some non-limiting embodiments or aspects, motor 208 may be aligned coaxially with the drive shaft. During processing of a drink product, motor 208 may be continuously operated at one or more speeds to drive continuous rotation of dasher 204 and, thereby, provide continuous mixing of the drink product within mixing vessel 104.

As referenced above, drink maker 100 may include a removably attachable drip tray 118, which may be moved from the operational position shown in FIGS. 1A-1D and 2. For example, drip tray 118 may be mounted and/or stored on a side panel of housing 102 (e.g., on ventilation panel 114). In some non-limiting embodiments or aspects, the rotation of dasher 204 may cause the helically arranged blades to push the cooling drink product to the front of mixing vessel 104. During processing, portions of the drink product may freeze against the surface of evaporator 202 as a result of being cooled by evaporator 202. In some non-limiting embodiments or aspects, the blades of the rotating dasher 204 may scrape frozen portions of the drink product from the surface of evaporator 202 while concurrently mixing and pushing the cooling drink product towards the front of mixing vessel 104.

Drink maker 100 may include a cooling circuit (e.g., a refrigeration system) to provide cooling of a drink product and/or to control the temperature of a drink product within mixing vessel 104. The cooling circuit may include a compressor 214, evaporator 202, a condenser 216, a condenser fan 218, a bypass valve, and conduit that carries refrigerant in a closed loop among the cooling circuit components to facilitate cooling and/or temperature control of a drink product in mixing vessel 104. Operations of the cooling circuit may be controlled by a controller, which may be positioned proximal to user interface 112, drive motor 208, and/or elsewhere in housing 102. In some non-limiting embodiments or aspects, drink maker 100 may include a printed circuit board assembly (PCBA) 222 of one or more printed circuit boards (PCBs) within housing 102. PCBA 222 may include, or be included in, a control system configured to automatically control certain operations of drink maker 100, and the control system may include a controller.

The control system of PCBA 222 may include, or be included in, a microcontroller, a processor, a system-on-a-chip (SoC), a client device, and/or a physical computing device and may include hardware and/or virtual processor(s). One or more elements of the control system of PCBA 222 may relate to physical hardware, while in some implementations one, more, or all of the elements could be implemented using emulators or virtual machines. Regardless, the control system of PCBA 222 may be implemented on physical hardware, such as in drink maker 100. The control system may also include communications interfaces, such as a network communication unit that could include a wired communication component and/or a wireless communications component, which may be communicatively coupled to a controller and/or a processor. Network communication units may utilize any of a variety of proprietary or standardized network protocols, such as Ethernet, transfer control protocol/internet protocol (TCP/IP), and/or the like, to effect communications between a processor and another device, network, or system. Network communication units may also comprise one or more transceivers that utilize the Ethernet, power line communication (PLC), Wi-Fi®, cellular, and/or other communication methods. For example, the control system may send one or more communications associated with a status of drink maker 100 to a mobile device of a user, e.g., send an alert to the mobile device when a recipe is complete and/or a drink product is ready for dispensing, or to indicate that the mixing vessel is low or out of a drink product.

In some non-limiting embodiments or aspects, the control system of PCBA 222 may include a processing element, such as a controller and/or a processor, that contains one or more hardware processors, where each hardware processor may have a single or multiple processor cores. In one implementation, the processor may include at least one shared cache that stores data (e.g., computing instructions) that are utilized by one or more other components of the processor. For example, the shared cache may be a locally cached data stored in a memory for faster access by components of the processing elements that make up the processor. Examples of processors include, but are not limited to, a central processing unit (CPU) and/or microprocessor. The controller and/or the processor may utilize a computer architecture base on, without limitation, the Intel® 8051 architecture, Motorola® 68HCX, Intel® 80×86, and the like. The processor may include, without limitation, an 8-bit, 12-bit, 16-bit, 32-bit, or 64-bit architecture. The processing elements that make up the processor may also include one or more other types of hardware processing components, such as graphics processing units (GPUs), application specific integrated circuits (ASICs), field-programmable gate arrays (FPGAs), and/or digital signal processors (DSPs).

In some non-limiting embodiments or aspects, memory may be operatively and communicatively coupled to the controller of the control system of PCBA 222. The memory may be a non-transitory medium configured to store various types of data. For example, the memory may include one or more storage devices that include a non-volatile storage device and/or volatile memory. Volatile memory, such as random-access memory (RAM), may be any suitable non-permanent storage device. The non-volatile storage devices may include one or more disk drives, optical drives, solid-state drives (SSDs), tape drives, flash memory, read-only memory (ROM), and/or any other type of memory designed to maintain data for a duration time after a power loss or shut down operation. In certain configurations, the non-volatile storage devices may be used to store overflow data if allocated RAM is not large enough to hold all working data. The non-volatile storage devices may also be used to store programs that are loaded into the RAM when such programs are selected for execution. Data store and/or storage devices may be arranged to store a plurality of drink product making and/or processing instruction programs associated with a plurality of drink product processing sequences, e.g., recipes. Such drink product making and/or processing instruction programs may include instructions for the controller and/or the processor to: start or stop one or motors and/or compressors (e.g., such as motor 208 and/or compressor 214), start or stop compressor 214 to regulate a temperature of a drink product being processed within mixing vessel 104, operate the one or more motors and/or compressors (e.g., motor 208 and/or compressor 214) at certain periods during a particular drink product processing sequence, operate motor 208 at certain speeds during certain periods of time of a recipe, issue one or more cue instructions to user interface 112 that are output to a user to illicit a response, action, and/or input from the user, and/or the like.

Persons of ordinary skill in the art are aware that software programs may be developed, encoded, and compiled in a variety of computing languages for a variety of software platforms and/or operating systems and subsequently loaded and executed by the processor of the control system of PCBA 222. In one implementation, the compiling process of the software program may transform program code written in a programming language to another computer language such that the processor is able to execute the programming code. For example, the compiling process of the software program may generate an executable program that provides encoded instructions (e.g., machine code instructions) for the processor to accomplish specific, non-generic, particular computing functions. After the compiling process, the encoded instructions may be loaded as computer executable instructions or process steps to the processor from storage, from memory, and/or embedded within processor (e.g., via a cache or on-board ROM). The processor may be configured to execute the stored instructions or process steps in order to perform instructions or process steps to transform the electronic control system into a non-generic, particular, specially programmed machine or apparatus. Stored data, e.g., data stored by a data store and/or storage device, may be accessed by the processor during the execution of computer executable instructions or process steps to instruct one or more components within the control system and/or other components or devices external to the control system. For example, the recipes may be arranged in a lookup table and/or database within the data store and be accessed by the processor when executing a particular recipe selected by a user via user interface 112.

In some non-limiting embodiments or aspects, the control system of PCBA 222 may include one or more sensors that detect and/or monitor conditions of a drink product within mixing vessel 104, conditions associated with a component of drink maker 100, and/or conditions of a refrigerant within the cooling circuit. Conditions may include, without limitation, rotation, speed of rotation, and/or movement of a device or component (e.g., a motor), rate of such movement, frequency of such movement, direction of such movements, motor current, motor voltage, motor power, motor torque, temperature, pressure, fluid level in mixing vessel 104, position of a device or component (e.g., whether pour-in opening 106 is open or closed), and/or the presence of a device or component (e.g., whether shroud 116 is installed or not). Types of sensors may include, for example, electrical metering chips, Hall sensors, pressure sensors, temperature sensors, optical sensors, current sensors, torque sensors, voltage sensors, cameras, other types of sensors, or any suitable combination of the foregoing. Drink maker 100 may include one or more temperature sensors positioned in various locations within mixing vessel 104 such as, for example, on or about the lower front area within mixing vessel 104, on or about the upper front area within mixing vessel 104, on or about the upper rear area within mixing vessel 104, within one or more coils of evaporator 202, and/or within housing 102.

In some non-limiting embodiments or aspects, the sensors of the control system of PCBA 222 may also include one or more safety and/or interlock switches that prevent or enable operation of certain components, e.g., a motor, when certain conditions are met (e.g., enabling activation of motor 208 when a lid or cover for opening 106 is attached or closed, when mixing vessel 104 is attached to upper housing section 122, and/or when a sufficient level of drink product is in mixing vessel 104).

In some non-limiting embodiments or aspects, the control system of PCBA 222, and/or the processor therein, may include a system-on-chip (SoC) having multiple hardware components, including but not limited to: a microcontroller, microprocessor, digital signal processor (DSP) core, and/or multiprocessor SoCs (MPSoCs) having more than one processor cores; memory blocks including a selection of ROM, RAM, electronically erasable programmable read-only memory (EEPROM), and flash memory; timing sources including oscillators and phase-docked loops; peripherals including counter-timers, real-time timers and power-on reset generators; external interfaces, including industry standards such as universal serial bus (USB), Fire Wire®, Ethernet, universal synchronous/asynchronous receiver/transmitter (USART), and serial peripheral interface (SPI); analog interfaces including analog-to-digital converters (ADCs) and digital-to-analog converters (DACs); and voltage regulators and power management circuits.

In some non-limiting embodiments or aspects, a SoC may include both the hardware, described above, and software controlling the microcontroller, microprocessor and/or DSP cores, peripherals and interfaces. SoCs may be developed from pre-qualified hardware blocks for the hardware elements (e.g., referred to as modules or components which represent an IP core or IP block), together with software drivers that control their operation. The above listing of hardware elements is not exhaustive. A SoC may include protocol stacks that drive interfaces like a universal serial bus (USB).

Referring now to FIGS. 3A-3C, shown are three views of a front of drink maker 100, according to some non-limiting embodiments or aspects. Specifically, FIG. 3A depicts a first use of drink maker 100 with a small receiving vessel 302a (e.g., an 8 oz cup). FIG. 3B depicts a second use of drink maker 100 with a medium receiving vessel 302b (e.g., a 12 oz cup). FIG. 3C depicts a third use of drink maker 100 with a large receiving vessel 302c (e.g., a 16 oz cup). While cups are shown for case of illustration, it will be appreciated that receiving vessels 302a, 302b, 302c may take alternate forms, such as bottles, glasses, bowls, mugs, and other containers configured to receive and retain the processed drink product.

With specific reference to FIG. 3A, after drink maker 100 has cooled and/or frozen the drink product in mixing vessel 104, a user may place a small receiving vessel 302a on drip tray 118, in the gap between a top surface of drip tray 118 and a bottom surface of the spout (e.g., covered and/or formed by shroud 116). Such a gap is demarcated by dimension H₃. The height of drip tray 118 and length of the spout may be minimized, so that dimension H₃ is maximized relative to the overall height of drink maker 100, and in balance with a high throughput of mixing vessel 104. By this configuration, drink maker 100 may easily accommodate small receiving vessel 302a within the space of dimension H₃. The user may dispense the drink product from drink maker 100 by pulling on handle 120, which opens an outlet (not shown) in mixing vessel 104 and allows the drink product to flow and/or be pushed from mixing vessel 104 by dasher 204. Gravity urges the drink product downward from the spout and into small receiving vessel 302a. Dimension H₃ is further configured such that small receiving vessel 302a may be placed and removed on drip tray 118 without scraping against shroud 116 or tilting small receiving vessel 302a such that dispensed drink product might be spilled. By way of further example, for a drink maker 100 with a maximum operational volume of 64 fluid ounces, the user may fill up small receiving vessel 302a, with a holding volume of 8 fluid ounces, up to eight times at maximum capacity. It will be appreciated, however, that drink products may increase in volume as they are cooled and frozen in drink maker 100, and the above illustration of volume for use of small receiving vessel 302a is for emphasis of the utility of drink maker 100 with its compact dimensions.

With specific reference to FIG. 3B, after drink maker 100 has cooled and/or frozen the drink product in mixing vessel 104, a user may place a medium receiving vessel 302b on drip tray 118, in the gap between a top surface of drip tray 118 and a bottom surface of the spout (e.g., covered and/or formed by shroud 116). Such a gap is demarcated by dimension H₃. The height of drip tray 118 and length of the spout may be minimized, so that dimension H₃ is maximized relative to the overall height of drink maker 100, and in balance with a high throughput of mixing vessel 104. By this configuration, drink maker 100 may easily accommodate medium receiving vessel 302b within the space of dimension H₃. The user may dispense the drink product from drink maker 100 by pulling on handle 120, which opens an outlet (not shown) in mixing vessel 104 and allows the drink product to flow and/or be pushed from mixing vessel 104 by dasher 204. Gravity urges the drink product downward from the spout and into medium receiving vessel 302b. Dimension H₃ is further configured such that medium receiving vessel 302b may be placed and removed on drip tray 118 without scraping against shroud 116 or tilting medium receiving vessel 302b such that dispensed drink product might be spilled. By way of further example, for a drink maker 100 with a maximum operational volume of 64 fluid ounces, the user may fill up medium receiving vessel 302b, with a holding volume of 12 fluid ounces, up to five and one-third times at maximum capacity. It will be appreciated, however, that drink products may increase in volume as they are cooled and frozen in drink maker 100, and the above illustration of volume for use of medium receiving vessel 302b is for emphasis of the utility of drink maker 100 with its compact dimensions.

With specific reference to FIG. 3C, after drink maker 100 has cooled and/or frozen the drink product in mixing vessel 104, a user may place a large receiving vessel 302c on drip tray 118, in the gap between a top surface of drip tray 118 and a bottom surface of the spout (e.g., covered and/or formed by shroud 116). Such a gap is demarcated by dimension H₃. The height of drip tray 118 and length of the spout may be minimized, so that dimension H₃ is maximized relative to the overall height of drink maker 100, and in balance with a high throughput of mixing vessel 104. By this configuration, drink maker 100 may easily accommodate large receiving vessel 302c within the space of dimension H₃. The user may dispense the drink product from drink maker 100 by pulling on handle 120, which opens an outlet (not shown) in mixing vessel 104 and allows the drink product to flow and/or be pushed from mixing vessel 104 by dasher 204. Gravity urges the drink product downward from the spout and into large receiving vessel 302c. Dimension H₃ is further configured such that large receiving vessel 302c may be placed and removed on drip tray 118 without scraping against shroud 116 or tilting large receiving vessel 302c such that dispensed drink product might be spilled. By way of further example, for a drink maker 100 with a maximum operational volume of 64 fluid ounces, the user may fill up large receiving vessel 302c, with a holding volume of 16 fluid ounces, up to four times at maximum capacity. It will be appreciated, however, that drink products may increase in volume as they are cooled and frozen in drink maker 100, and the above illustration of volume for use of large receiving vessel 302c is for emphasis of the utility of drink maker 100 with its compact dimensions.

Referring now to FIGS. 4A-4B, shown are two views of a mixing vessel 104 and dispenser assembly 108 of drink maker 100, according to some non-limiting embodiments or aspects. Specifically, FIG. 4A depicts a perspective view of mixing vessel 104 and dispenser assembly 108 of drink maker 100. FIG. 4B depicts a front view of mixing vessel 104 and dispenser assembly 108 of drink maker 100. While the cross-sectional shape of a profile of mixing vessel 104 is shown to be substantially stadium in geometry, it will be appreciated that other shapes and geometries may be used for mixing vessel 104.

In some non-limiting embodiments or aspects, mixing vessel 104 may be configured to hold a maximum liquid volume of drink product that is greater than or equal to 64 fluid ounces, which is 2 quarts, or half a gallon. In some non-limiting embodiments or aspects, mixing vessel 104 may be configured to hold a maximum liquid volume of drink product that is greater than or equal to 80 fluid ounces. The maximum liquid volume may be measured when mixing vessel 104 is coupled to upper housing section 122, with evaporator 202 and dasher 204 enclosed within mixing vessel 104. Drink product that is to be processed may be poured into mixing vessel 104 via pour-in opening 106. Maximum operational volume, which is a maximum recommended fill volume within mixing vessel 104 at the beginning of processing, may be less than or equal to a maximum liquid volume of mixing vessel 104. Maximum operational volume may be demarcated on an exterior face of mixing vessel 104 by way of a maximum fill indicator 173 (e.g., a line, symbols, words, letters, or other demarcation). With an at least partly transparent-walled mixing vessel 104, the user may use maximum fill indicator 173 as a visual guide for the maximum drink product to place within mixing vessel 104. When the liquid level inside mixing vessel 104 is below or at maximum fill indicator 173, the user may cease filling mixing vessel 104. For example, when the liquid level inside mixing vessel 104 is level with maximum fill indicator 173, the maximum operational volume may be 64 fluid ounces, and the maximum liquid volume of mixing vessel 104 as a whole may be 80 fluid ounces, to allow for headroom and expansion of drink product.

In some non-limiting embodiments or aspects, mixing vessel 104 may be configured to process at least a minimum operational volume of drink product, at which amount there is a minimum sufficient volume of drink product touching evaporator 202 that processing is possible. Minimum operational volume may be demarcated on an exterior face of mixing vessel 104 by way of a minimum fill indicator 171 (e.g., a line, symbols, words, letters, or other demarcation). With an at least partly transparent-walled mixing vessel 104, the user may use minimum fill indicator 171 as a visual guide for the minimum drink product to place within mixing vessel 104 before beginning processing by drink maker 100. The user may continue to fill mixing vessel 104 with drink product at least until the liquid level inside mixing vessel 104 is level with minimum fill indicator 171. For example, when the liquid level inside mixing vessel 104 is level with minimum fill indicator 171, the minimum operational volume may be 16 fluid ounces, to allow for sufficient contact of drink product with evaporator 202.

In some non-limiting embodiments or aspects, a vertical distance from a lowest point of mixing vessel 104 to maximum fill indicator 173 may be greater than or equal to 65% of the maximum vertical dimension of mixing vessel 104 (dimension H₄). In this manner, surplus headroom is minimized, which might otherwise contribute to an overly bulky form factor for drink maker 100, preventing use and storage on a consumer countertop. Moreover, surplus headroom may reduce the operational throughput of drink maker 100, reducing utility. The relation of maximum fill indicator 173 to the overall height of mixing vessel 104 (dimension H₄) is configured to allow for drink product expansion due to cooling, but it is also balanced against space-saving for the overall dimensionality of drink maker 100. For example, if the overall height of mixing vessel 104 (dimension H₄) is 7 inches, maximum fill indicator may be at least 4.55 inches vertically up the front face of mixing vessel 104 (as measured from the lowest point of mixing vessel 104). By way of further example, the volume of liquid contained in mixing vessel 104 at a level of maximum fill indicator 173 may be greater than or equal to 70% of a total liquid volume of mixing vessel. For a total liquid volume of 64 fluid ounces, the liquid volume when level with max fill indicator 173 may be approximately 45 fluid ounces or greater. For a total liquid volume of 80 fluid ounces, the liquid volume when level with max fill indicator 173 may be approximately 56 fluid ounces or greater.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect may be combined with one or more features of any other embodiment or aspect.

What is claimed is:

1. A drink maker comprising:
a mixing vessel configured to receive a drink product;
a base configured to support the mixing vessel;
a dasher configured to mix the drink product within the mixing vessel; and
a cooling circuit configured to cool the drink product within the mixing vessel,
wherein a total height of the drink maker is less than 20 inches.

2. The drink maker of claim 1, wherein a total height of the drink maker is less than 18 inches.

3. The drink maker of claim 1, wherein a vertical distance from a lowest point of the base to a lowest point of the mixing vessel is between 50% and 60% of the total height of the drink maker.

4. The drink maker of claim 1, wherein the mixing vessel is configured to hold a maximum liquid volume of the drink product that is greater than or equal to 64 fluid ounces.

5. The drink maker of claim 4, wherein the mixing vessel comprises a maximum fill indicator on a front face of the mixing vessel, and wherein a vertical distance from a lowest point of the mixing vessel to the maximum fill indicator is greater than or equal to 65% of a maximum height of the mixing vessel.

6. The drink maker of claim 1, further comprising an evaporator configured to (i) enclose, on an interior of the evaporator, at least part of the cooling circuit, and (ii) contact, on an exterior of the evaporator, the drink product in the mixing vessel.

7. The drink maker of claim 6, wherein a major axis of the evaporator is substantially perpendicular to a vertical axis of the drink maker.

8. The drink maker of claim 7, wherein the dasher is configured to engage over at least part of the evaporator and rotate about a rotational axis that is parallel to the major axis of the evaporator.

9. The drink maker of claim 8, wherein the dasher is configured to urge the drink product from a first end of the mixing vessel to a second end of the mixing vessel, in a direction parallel to the major axis.

10. The drink maker of claim 9, further comprising a dispenser assembly disposed at the second end of the mixing vessel and configured to release the drink product from the mixing vessel.

11. The drink maker of claim 1, further comprising:
a drip tray detachably connectable to the base of the drink maker; and
a spout fluidly connected to an interior of the mixing vessel and configured to direct the drink product that is released from the mixing vessel into a secondary container.

12. The drink maker of claim 11, wherein a minimum vertical distance between a top surface of the drip tray and a bottom surface of the spout is greater than or equal to 35% of the total height of the drink maker.

13. The drink maker of claim 12, wherein a minimum vertical distance between a top surface of the drip tray and a bottom surface of the spout is greater than or equal to 45% of the total height of the drink maker.

14. The drink maker of claim 13, further comprising a user interface for control of the drink maker, the user interface arranged on a front face of the drink maker in a space defined between the top surface of the drip tray and the bottom surface of the spout.

15. The drink maker of claim 1, wherein a depth of an interior volume of the mixing vessel along a first axis is greater than or equal to 50% of a total depth of the drink maker as measured along the first axis, wherein the first axis is perpendicular to the vertical axis and extends from a front of the drink maker to a rear of the drink maker.

16. The drink maker of claim 15, wherein a width of an interior volume of the mixing vessel along a second axis is greater than or equal to 65% of a total width of the drink maker as measured along the second axis, wherein the second axis is perpendicular to the first axis and perpendicular to the vertical axis.

17. The drink maker of claim 16, wherein the total width of the drink maker is less than or equal to 7 inches.

18. The drink maker of claim 1, further comprising a compressor connected to the cooling circuit, wherein the compressor is housed within the base, and wherein the compressor is arranged vertically below the mixing vessel.

19. A drink maker comprising:
a mixing vessel configured to receive a drink product;
a base configured to support the mixing vessel;
a dasher configured to mix the drink product within the mixing vessel; and
a cooling circuit configured to cool the drink product within the mixing vessel,
wherein a maximum height of the mixing vessel along a vertical axis is greater than or equal to 40% of a total height of the drink maker.

20. The drink maker of claim 19, wherein the total height of the drink maker is less than 20 inches.
